(19) United States
(12) Patent Application Publication
(10) Pub. No.: US 2005/0071511 A1
(43) Pub. Date: Mar. 31, 2005

(54) Self-activating network connection system and method

(76) Inventor: Chih-Wei Chen, Taipei (TW)

Correspondence Address: BIRCH STEWART KOLASCH & BIRCH, PO BOX 747, FALLS CHURCH, VA, 22040-0747, US

(21) Appl. No.: 10/776,527

(22) Filed: Feb. 12, 2004

(30) Foreign Application Priority Data
Sep. 29, 2003 (TW) 092126780

(51) Int. Cl. G06F 15/16

(52) U.S. Cl. 709/250

(57) ABSTRACT

A self-activating network connection system and method is suitable for a computer system capable of network connection. The computer system at least includes a network connection module for connecting to a network and a network driving module for driving the network connection module to perform network connection. When the computer system is turned on and counts to a predetermined value, the status of network connection is detected. If successful connection between the computer system and the network is detected, then counting and detection stop. If failure in connection between the computer system and the network is detected, then an activation signal is output to the network driving module and counting is restarted, such that the computer system sends information required for network initialization to the network driving module, which subsequently drives the network connection module with the information to perform the network connection process.

### FIELD OF THE INVENTION

The present invention relates to computer network connection technology, and more particularly, to a self-activating network connection system and method.

### BACKGROUND OF THE INVENTION

When a computer connects to a network, a network driving program inside the operating system of the computer automatically initializes the network connection, such that a series of network-connection processes are performed, wherein an IP (Internet Protocol) address for the computer system (i.e. the address on the network) has to be obtained in advance before connecting to the network so as to perform subsequent network connection processes.

However, usually the computer system only performs the network driving program once at startup to allow a network chip for connecting to the network to execute network initialization. Thus, if the computer cannot properly connect to the network at startup, for example, in the case of a network cable of the computer is not physically connected to the network making the network chip fail to obtain the IP address of the computer via the network cable, then the network initialization cannot operate normally. Under such circumstances, users first have to ensure that all requirements for network connection have been met, and then either restart the computer system or reset parameters that perform the network initialization script in order to establish network connectivity. However, restarting the computer or resetting the parameters is not an efficient or convenient solution. Restarting the computer increases the time for network connection and resetting the parameters requires specialized knowledge. General users would find the latter method rather difficult to re-initialize the network chip for network connection, such that the users typically resort to restarting the computer, which wastes time.

### SUMMARY OF THE INVENTION

To address the problems of the prior art, a primary objective of the present invention is to provide a self-activating network connection system and method which self-activates a network initialization process for a computer system such that manual setting of parameters or restarting the computer system become unnecessary.

To achieve the above and other objectives, the present invention provides a self-activating network connection system and method, suitable for a computer system that is able to connect to a network, which detects the status of network connection of the computer system automatically at startup without human interference. If the detection result indicates that the computer system has not successfully connected to the network, the network initialization process self-activates to attempt to connect to the network repeatedly until successful.

The self-activating network connection system of the present invention is suitable for a computer system capable of network connection, the computer system comprising at least a network driving module and a network connection module. The network connection module is used to connect to the network, and the network driving module is used to drive the network connection module to connect to the network. The self-activating network connection system comprises a detection module and an activation module. The detection module performs a count process to count to a predetermined value, and then the detection module detects whether the computer system is connected to the network or not. If the network connection has not yet been established, then the detection module outputs a signal to the activation module and restarts counting. Upon receiving the signal from the detection module, the activation module then sends the information required for activating network initialization and connection to the network driving module, such that the network driving module subsequently drives the network connection module with this information to perform the network connection process. This process repeats until the network connection module connects to the network.

The self-activating network connection method according to the present invention is suitable for a computer system that is capable of network connection, wherein the computer system has at least a network connection module and a network driving module. The self-activating network connection method comprises the following steps: performing a counting process after the computer has been turned on; after counting to a predetermined value, the computer system determining whether the network connection module is successfully connected to the network, if yes, terminating the counting procedure, if no, sending an activation signal with the information required for network initialization and connection to the network driving module by the computer system, so as to allow the network driving module to drive the network connection module to perform the network connection process until the network connection module successfully connects to the network. The operations of the network driving module and the network connection module are performed according to well-known standard network connection techniques.

### BRIEF DESCRIPTION OF THE DRAWINGS

The present invention can be more fully understood by reading the following detailed description of the preferred embodiments, with reference made to the accompanying drawings, wherein:

FIG. 1 is a schematic block diagram showing basic architecture of a self-activating network connection system according to the present invention;

FIG. 2(A) is a flow chart showing procedural steps for a self-activating network connection method according to the present invention; and

FIG. 2(B) is a flow chart showing procedural steps for the self-activating network connection method according to the present invention in the case of the computer system unable to obtain an IP address.

### DETAILED DESCRIPTION OF THE PREFFERED EMBODIMENT

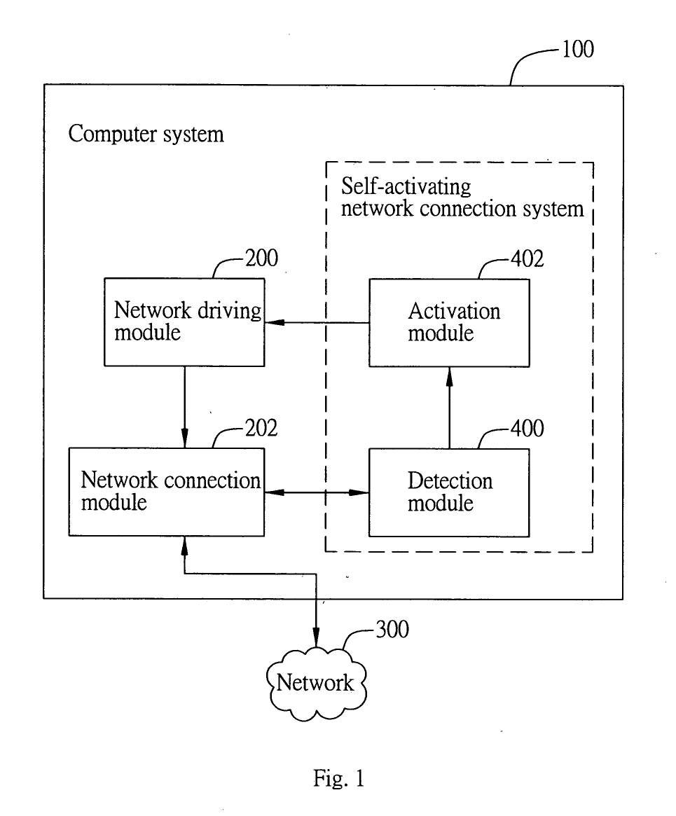

FIG. 1 shows the basic architecture of a self-activating network connection system proposed by the present invention. As shown, this self-activating network connection system is constructed within a computer system 100 having a network connection module 202 and a network driving module 200 used to drive the network connection module 202 to obtain and store an IP address associated with the computer system 100. The IP address comes from a network 300 external to the computer system 100, which can be an Internet or Intranet.

The self-activating network connection system constructed in the computer system 100 includes a detection module 400 having counting and detection functions and an activation module 401. Generally, when the computer system 100 is turned on, the network connection module 202 is triggered to connect to the network 300 in order to obtain an IP address, such that the computer system 100 can be connected to the network 300 based on the IP address. Moreover, after the computer system 100 is turned on, the detection module 400 starts performing a counting process. When the detection module 400 counts to a predetermined value, it detects whether the IP address of the computer system 100 has been obtained by the network connection module 202. If the network connection module 202 has not obtained the IP address, the detection module 400 sends a signal to the activation module 402, and the activation module 402 in turn sends an activation signal to the network driving module 200, to allow the network driving module 200 to send the required information to the network connection module 202, prompting the network connection module 202 to make another attempt to connect to the network 300. The required information includes new parameter settings needed for network initialization and connection.

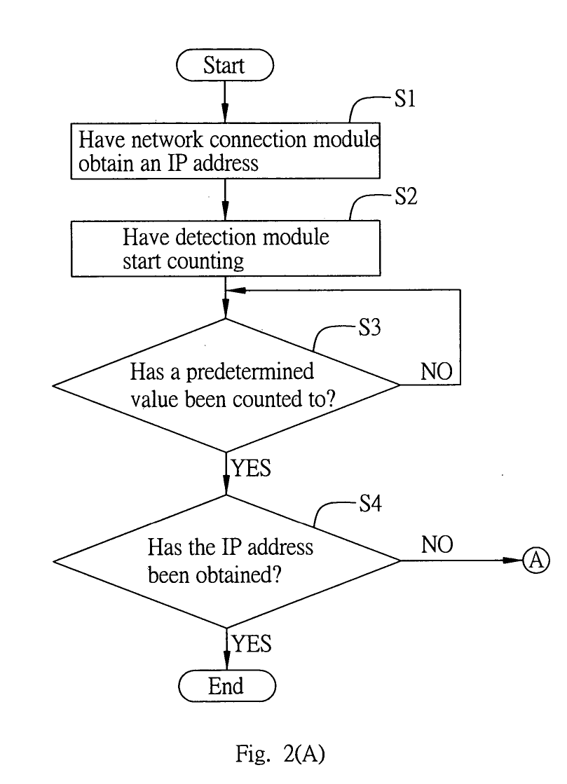

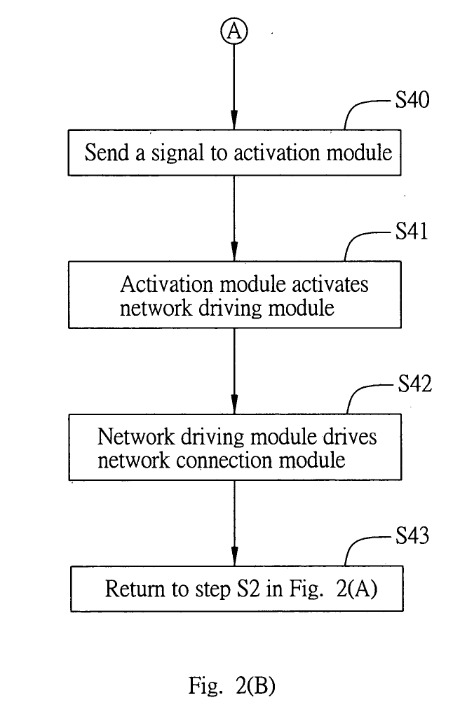

FIG. 2(A) shows the procedural steps for a self-activating network connection method according to the present invention in the use of the above self-activating network connection system. As shown, after the computer system 100 is turned on, step S1 is carried out such that the network connection module 202 attempts to obtain an IP address for the computer system 100 via the network 300; then step S2 is performed.

In step S2, the detection module 400 starts performing the counting process, then proceeding to step S3.

In step S3, the computer system 100 determines whether the detection module 400 has counted to a predetermined value. If yes, proceed to step S4; if no, return to step S3.

In step S4, the computer system 100 determines if the network connection module 202 has obtained the IP address of the computer system 100. If no, have the computer system 100 proceed to point A of FIG. 2(B); if yes, terminate the network connection process.

Before the computer system 100 moves to point A, the detection module 400 resets the count value to zero and begins counting again to the predetermined value in order to periodically determine if the network connection module 202 has obtained the IP address. Once the IP address is detected, the detection module 400 stops the counting process.

FIG. 2(B) shows the procedural steps for the self-activating network connection method when the network connection module 202 is unable to obtain an IP address. As shown, in step S40, the detection module 400 sends a signal to the activation module 402 to activate the subsequent network connection actions, then proceeding to step S41.

In step S41, the activation module 402 sends the required information, such as the parameter settings for the network initialization process, to the network driving module 200, then proceeding to step S42.

In step S42, the network driving module 200 drives the network connection module 202 to perform network connection actions in accordance with the network driving method in the prior art. Next, proceed to step S43.

In step S43, after the network connection module 202 has performed the network connection actions, return to step S2 in FIG. 2(A), such that the computer system 100 periodically determines whether the network connection module 202 obtains the IP address until this IP address has been obtained.

In this embodiment the detection module 400 is used to detect whether the network connection module 202 has obtained an IP address for the computer system 100. It should be understood that the detection module 400 may also be use to detect other signals indicating the status of network connection of the computer system 100, for example, the network usage loading after the computer system 100 connects to the network 300, etc. Such status signals need not be stored only in the network connection module 202, but can be stored elsewhere in the computer system 100.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A self-activating network connection system suitable for a computer system capable of network connection, the computer system at least having a network connection module for connecting to a network and a network driving module for driving the network connection module to perform network connection, the network connection system comprising:
a detection module for performing a counting process to count to a predetermined value where the detection module detects whether the network connection module has successfully connected to the network; and
an activation module for sending required information to the network driving module, such that if the detection module determines that the computer system fails to connect to the network via the network connection module, the activation module sends an activation signal to the network driving module to trigger the network driving module to drive the network connection module to connect to the network until the detection module determines that the computer system has successfully connected to the network via the network connection module.

2. The system as claimed in claim 1, wherein the information comprises parameter settings required for performing network initialization.

3. The system as claimed in claim 1, wherein the detection action performed by the detection module is to determine whether the network connection module has obtained an IP (Internet Protocol) address of the computer system.

4. A self-activating network connection method suitable for a computer system capable of network connection, the computer system at least having a network connection module for connecting to a network and a network driving module for driving the network connection module to perform network connection, the method comprising the following steps:
(1) performing a counting process after the computer system is turned on;
(2) having the computer system determine whether the counting process has counted to a predetermined value; if no, returning to step (2) to continue the counting process; if yes, proceeding to step (3);
(3) having the computer system detect whether the network connection module has connected to the network; if yes, having the computer system connect to the network via the network connection module and terminating the self-activating network connection process; if no, proceeding to step (4);
(4) having the computer system send an activation signal and information required for the network connection process to the network driving module; and
(5) having the network driving module drive the network connection module to perform the network connection process, and having the computer system perform the counting process again from the beginning and returning to step (2).

5. The method as claimed in claim 4, wherein the information comprises parameter settings required for performing network initialization.

6. The method as claimed in claim 4, wherein the detection action performed by the computer system is to determine whether the network connection module has obtained an IP address of the computer system.
